(19) United States
(12) Patent Application Publication
(10) Pub. No.: US 2016/0039154 A1
(43) Pub. Date: Feb. 11, 2016

(54) INSERT MEMBER, SHEET PAD, AND METHOD FOR PRODUCING SHEET PAD

(71) Applicant: TOYO TIRE & RUBBER CO., LTD., Osaka (JP)

(72) Inventor: Manabu Mogi, Osaka-shi (JP)

(73) Assignee: TOYO TIRE & RUBBER CO., LTD., Osaka (JP)

(21) Appl. No.: 14/810,782

(22) Filed: Jul. 28, 2015

(30) Foreign Application Priority Data
Aug. 6, 2014 (JP) 2014-160750

(51) Int. Cl. B29C 70/78; H01F 1/01

(52) U.S. Cl. CPC B29C 70/78; H01F 1/01; B29L 2031/58

(57) ABSTRACT

[Object] Provided is an insert member which can simplify the work for imparting magnetism.

[Solution] An insert member, such as a reinforcing fabric 1, is integrated with a pad body 52 made of expanded synthetic resin and usable for seats mounted on automobiles, boats, ships, aircraft, and other vehicles, furniture chairs, and the like. A magnetic layer 5 formed on the surface of the insert member is a cured form of an adhesive mixed with ferromagnetic powder of a metal, such as iron or nickel, or a metal oxide, such as ferrite. Therefore, the work for imparting magnetism to the insert member can be simplified.

### TECHNICAL FIELD

The present invention relates to an insert member, a sheet pad, and a method for producing the sheet pad.

### BACKGROUND ART

Sheet pads made of expanded synthetic resin are used for seats mounted on automobiles, boats, ships, aircraft, and other vehicles, furniture chairs, and the like. A sheet pad is produced so that any of a variety of insert members is integrated with a pad body made of expanded synthetic resin (see Patent Literature 1). Patent Literature 1 discloses a technique of sewing magnetic yarns into an insert member (reinforcing fabric) and attracting the magnetic yarns to a mold with magnets disposed on the mold to thereby secure the insert member to the mold. Then, by molding a pad body of expandable synthetic resin in the mold inside which the insert member is secured thereto, a sheet pad including the insert member integrated with the pad body is obtained.

### CITATION LIST

### Patent Literature

### [Patent Literature 1] JP-A No. 2008-142925

### SUMMARY OF INVENTION

### Technical Problem

However, in the above-described known technique, the work for sewing the magnetic yarns into the insert member to impart magnetism to the insert member is cumbersome.

The present invention has been made to solve the above problem and, therefore, an object thereof is to provide an insert member, a sheet pad, and a method for producing the sheet pad each of which can simplify the work for imparting magnetism.

### Solution to Problem and Advantageous Effects of Invention

To attain the above object, an insert member according to claim 1 is an insert member capable of being integrated with a pad body made of expanded synthetic resin, wherein a magnetic layer in which an adhesive mixed with ferromagnetic powder is cured is formed on a surface of the insert member. Since the magnetic layer formed on the surface of the insert member is a cured form of an adhesive mixed with ferromagnetic powder, this gives the effect of simplifying the work for imparting magnetism.

In an insert member according to claim 2, the magnetic layer has flexibility and, therefore, can follow the deformation of the insert member involved in the flexion of the pad body. Accordingly, the insert member has, in addition to the effect of claim 1, the effect of preventing delamination and breakage of the magnetic layer due to the deformation of the insert member.

In a sheet pad according to claim 3, the insert member is integrated with a pad body made of expanded synthetic resin. Since the magnetic layer formed on the surface of the insert member is a cured form of an adhesive mixed with ferromagnetic powder, this gives the effect of simplifying the work for imparting magnetism to the insert member.

In a method for producing a sheet pad according to claim 4, in a securing step, the insert member is secured to a mold by attracting the magnetic layer by a magnetic force. In a molding step, a pad body of expandable synthetic resin is molded in the mold inside which the insert member is secured thereto, thereby integrating the insert member with the pad body. Since the magnetic layer is formed on the surface of the insert member by curing an adhesive mixed with ferromagnetic powder, this gives the effect of simplifying the work for imparting magnetism to the insert member.

In a method for producing a sheet pad according to claim 5, the securing step includes securing the insert member so that a portion of the insert member having the magnetic layer formed thereon and the mold sandwich another portion of the insert member therebetween. Because the portions of the insert member are secured in a superposed relation by a magnetic force, the method has, in addition to the effect of claim 4, the effect of increasing the workability in securing the insert member to the mold.

### BRIEF DESCRIPTION OF DRAWING

FIG. 1 is a plan view of a reinforcing fabric to be integrated with a sheet pad in a first embodiment of the present invention.

FIG. 2 is a plan view of upholstery engaging members to be integrated with the sheet pad.

FIG. 3 is a bottom view of an upper mold.

FIG. 4 is a plan view of a lower mold.

FIG. 5A is a cross-sectional view of the sheet pad in a front-to-rear direction and FIG. 5B is a cross-sectional view of the sheet pad in a right-to-left direction.

FIG. 6 is a plan view of a reinforcing fabric in a modification.

FIG. 7A is a side view of an upholstery engaging member in a modification, FIG. 7B is a side view of an upholstery engaging member in another modification, and FIG. 7C is a side view of an upholstery engaging member in still another modification.

FIG. 8A is a perspective view of an expanded resin body to be integrated with a sheet pad in a second embodiment and FIG. 8B is a perspective view of an expanded resin body in a modification.

FIG. 9 is a bottom view of an upper mold.

FIG. 10A is a cross-sectional view of an upper mold in a right-to-left direction and FIG. 10B is a cross-sectional view of a mold during molding of a pad body.

### DESCRIPTION OF EMBODIMENTS

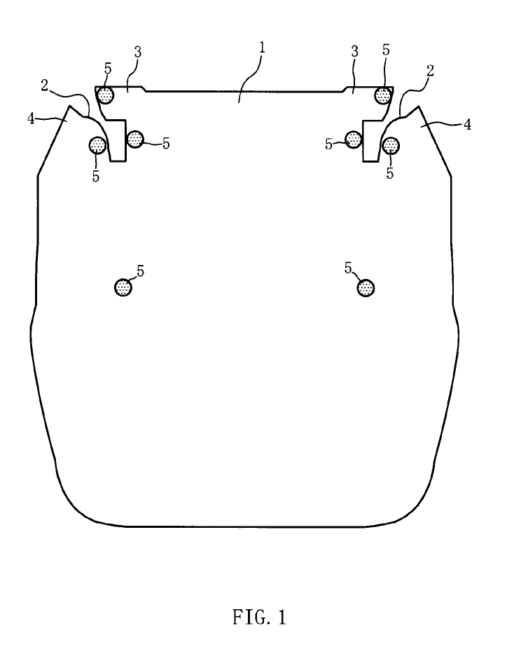

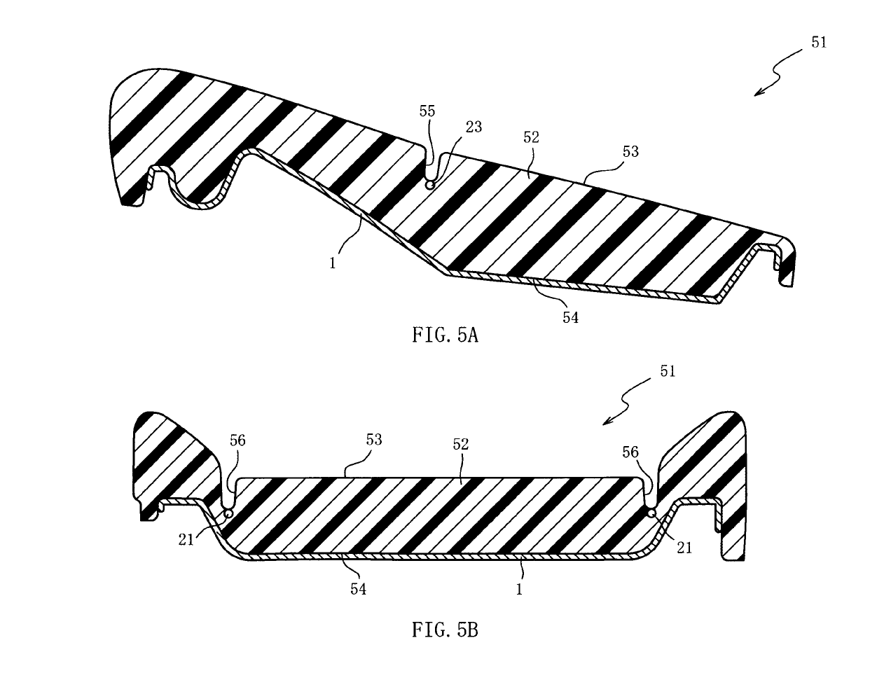

Hereinafter, a description will be given of a preferred embodiment of the present invention with reference to the accompanying drawings. Referring first to FIG. 1, a description will be given of a reinforcing fabric 1 (insert member) to be integrated with a sheet pad 51 (see FIG. 5A) in a first embodiment. FIG. 1 is a plan view of the reinforcing fabric 1.

The reinforcing fabric 1 is a member for preventing occurrence of abnormal noises due to friction against a sheet frame (not shown) to which the sheet pad 51 is to be mounted or other factors and damage to a pad body 52 (see FIG. 5A) and is provided integrally on the back surface of the pad body 52. The reinforcing fabric 1 is formed of non-woven fabric, such as coarse wool fabric, cheesecloth, muslin or felt, woven fabric, knit fabric, or a laminated composite of them. The reinforcing fabric 1 is formed in an approximately rectangular shape in plan view and provided at adjacent two corners with respective approximately V-shaped notches 2 to form pairs of end edges 3, 4 facing each other with one notch 2 in between.

Magnetic layers 5 are formed, one at each of the root and distal end of the end edge 3, one at the root of the end edge 4, and some around the center of the reinforcing fabric 1. The magnetic layers 5 are portions where an adhesive mixed with ferromagnetic powder is cured and are applied to and impregnated in the front surface (one surface) of the reinforcing fabric 1. What are used as the ferromagnetic powder to be mixed into the adhesive are metals, such as iron and nickel, and metal oxides, such as ferrite. Since ferromagnetic powder is mixed into the adhesive, the magnetic layers 5 with the adhesive cured can be attracted to magnets. By disposing magnets on a mold and attracting the magnetic layers 5 to the magnets, the reinforcing fabric 1 can be secured to the mold.

What are used as the adhesive are substances containing as a major ingredient one or more selected from natural polymer compounds, such as natural rubber; and synthetic polymer compounds, including synthetic resins, such as melamine resin, urea resin, phenol resin, polyvinyl acetate resin, ethylene-vinyl acetate resin, epoxy resin, cyanoacrylate resin, and acrylic resin, and synthetic rubbers, such as chloroprene rubber, nitrile rubber, styrene-butadiene rubber, and silicone rubber. Alternatively, adhesives that can be used include light curing resins containing polymerizable monomer or oligomer and a polymerization initiator. The adhesive that should be appropriately selected is an adhesive whose major ingredient (polymer compound) can adhere to the insert member. Furthermore, the adhesive used is an adhesive imparting flexibility to the magnetic layers 5 after their adhesive has cured.

For the purposes of adjusting the viscosity and imparting tackiness and other purposes, various additives, such as a solvent, a tackifier, and a plasticizer, are added to the adhesive depending upon not only the type of the polymer compound (major ingredient) but also the type of the insert member (permeability and so on). Adhesives that can be appropriately used are those in liquid form at ordinary temperature before curing, those in solid form at ordinary temperature before curing (so-called hot-melt adhesives), and so on, and, if necessary, a curing agent, a cross-linking agent, a bulking agent, a thickener, a pigment and/or so on may be added to the adhesive.

Furthermore, adhesives that can be used include two-component adhesives whose two liquid components are mixed when used. In the case of using such a two-component adhesive, ferromagnetic powder may be previously mixed into one of the two liquid components.

The magnetic layers 5 are formed on the surface of the insert member by various means, such as application of the adhesive with a brush, screen printing, spray, roller, glue gun or so on, transfer (application) of the adhesive applied on a stamp surface, or dipping. By any of these means, the adhesive can be easily applied to any location on the reinforcing fabric 1 (insert member). Since the magnetic layers 5 are cured forms of the adhesive mixed with ferromagnetic powder, the work for imparting magnetism to the reinforcing fabric 1 (the work for forming the magnetic layers 5) can be simplified. Therefore, the workability in imparting magnetism to the reinforcing fabric 1 can be increased. Furthermore, since the adhesive is impregnated between fibers of the reinforcing fabric 1, its anchoring effect provides firm adhesion of the magnetic layers 5 to the reinforcing fabric 1.

Since the magnetic layers 5 are cured forms of the adhesive mixed with ferromagnetic powder, the magnetic layers 5 can be stained the color of the ferromagnetic powder. As a result, it can be visually confirmed from color difference where the magnetic layers 5 are formed on the reinforcing fabric 1. Thus, a worker can fit the reinforcing fabric 1 to a mold while visually checking the positions of the magnetic layers 5, which can increase the workability in fitting the reinforcing fabric 1 to the mold.

In this embodiment, the adhesive is applied to the reinforcing fabric 1 by applying the adhesive on a circular stamp surface and then transferring the adhesive from the stamp surface to the reinforcing fabric 1. As a result, circular magnetic layers 5 are formed on the surface of the reinforcing fabric 1. By transferring the adhesive applied on the stamp surface to the reinforcing fabric 1, magnetic layers 5 having the same shape as the stamp surface can be formed. By the use of the stamp surface, the size and shape of the magnetic layers 5 can be easily and accurately controlled.

Furthermore, before the adhesive applied to the distal ends of the end edges 3 cures, the distal ends of the end edges 4 are superposed on the adhesive. Thus, both the distal ends of the end edges 3, 4 can be bonded together concurrently with the formation of the magnetic layers 5 due to curing of the adhesive. As a result, curved surfaces can be easily formed at corners of the reinforcing fabric 1. Whereas curved surfaces conventionally have been formed at corners of a reinforcing fabric 1 by sewing together each pair of end edges 3, 4 facing each other with a notch 2 in between, the sewing work can be omitted by using the above adhesive.

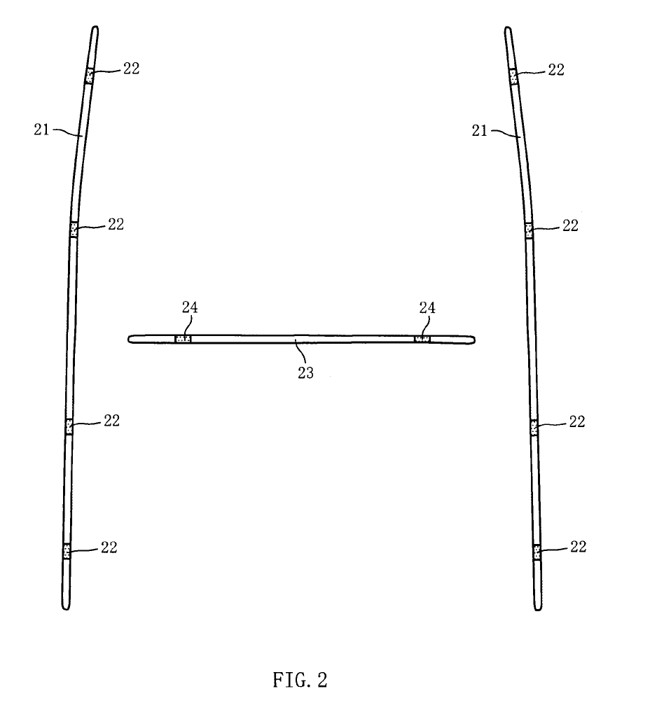

Referring next to FIG. 2, a description will be given of upholstery engaging members 21, 23 (insert members) to be integrated with a sheet pad 51 (see FIG. 5A). FIG. 2 is a plan view of the upholstery engaging members 21, 23 to be integrated with the sheet pad 51.

The upholstery engaging members 21, 23 are bar-like members for engaging an upholstery (not shown) covering the surface of the sheet pad 51 and have flexibility. In this embodiment, the upholstery engaging members 21, 23 are round bar-like members made of synthetic resin having different lengths from each other. No particular limitation is placed on the synthetic resin forming the upholstery engaging members 21, 23 and the synthetic resin is appropriately selected in consideration of mechanical strength and so on. For example, polyolefin, such as polypropylene, or fiber-reinforced resin obtained by reinforcing resin with glass fibers or other fibers can be used. Furthermore, the upholstery engaging members 21, 23 are not limited to bar-like members and it is naturally possible to use cord-like members. Moreover, the upholstery engaging members 21, 23 are not limited to those made of synthetic resin and it is naturally possible to make them from copper, aluminum or like metal which itself cannot be attracted to magnets.

Each of the upholstery engaging members 21, 23 has a plurality of magnetic layers 22, 24 which are formed thereon at intervals in the length direction and have flexibility. The magnetic layers 22, 24 are formed on the outer peripheries of the upholstery engaging members 21, 23 annularly in the circumferential direction thereof by an adhesive mixed with a ferromagnetic.

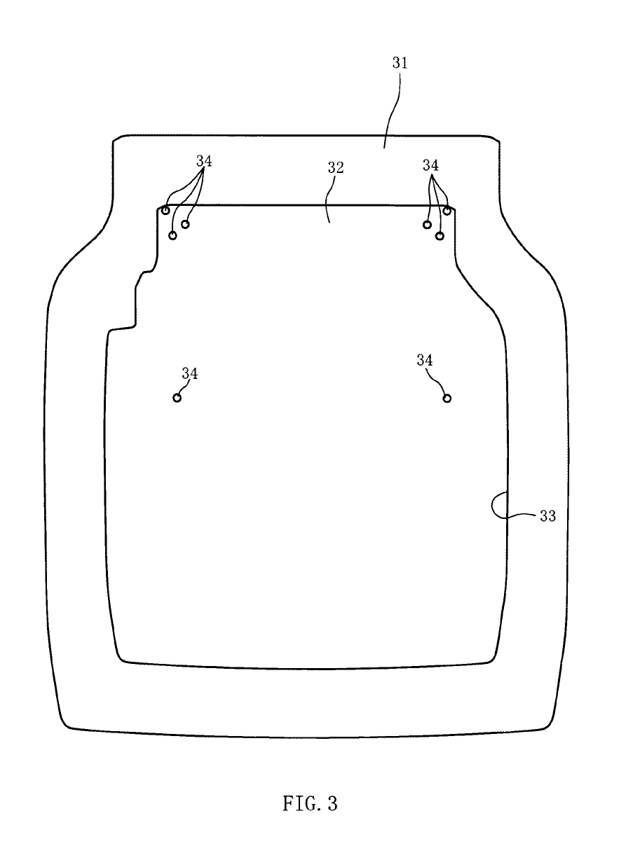

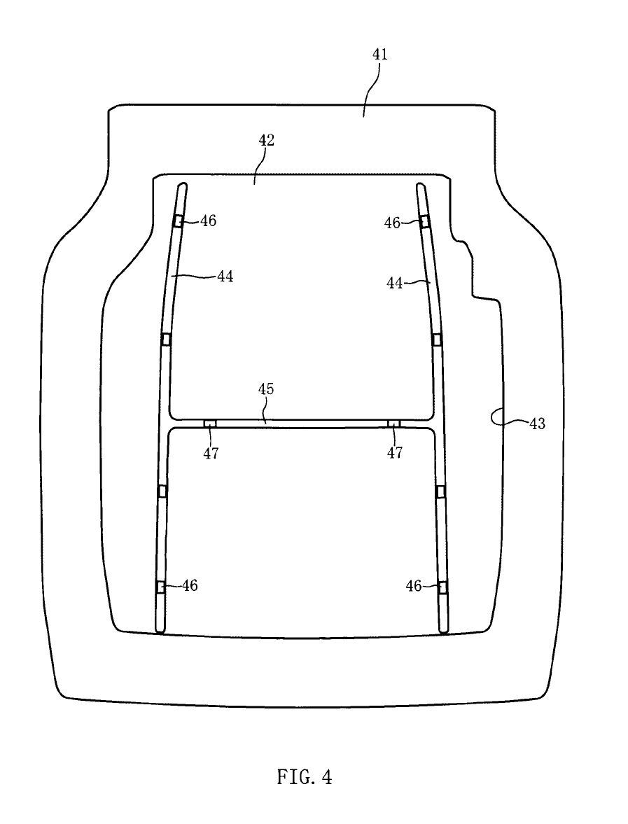

Referring next to FIGS. 3 to 5, a description will be given of: a mold to which the reinforcing fabric 1 and the upholstery engaging members 21, 23 are to be secured; and a sheet pad 51 molded by the mold. FIG. 3 is a bottom view of an upper mold 31 (a part of the mold) and FIG. 4 is a plan view of a lower mold 41 (another part of the mold). FIG. 5A is a cross-sectional view of the sheet pad 51 in a front-to-rear direction and FIG. 5B is a cross-sectional view of the sheet pad 51 in a right-to-left direction.

As shown in FIG. 3, the upper mold 31 is a member for molding the back surface 54 side of the pad body 52, wherein a molding surface 32 is formed at the bottom surface of a cavity 33. The upper mold 31 is made of aluminum alloy and includes magnets 34 (permanent magnets) embedded at a plurality of locations in the molding surface 32. The magnets 34 are members for attracting the magnetic layers 5 formed on the reinforcing fabric 1 (see FIG. 1) by a magnetic force. The magnetic layers 5 are formed on the reinforcing fabric 1 corresponding to the relative positions of the magnets 34 to the upper mold 31.

As shown in FIG. 4, the lower mold 41 is a member for molding the front surface 53 side of the pad body 52, wherein a molding surface 42 is formed at the bottom surface of a cavity 43. By superposing the lower mold 41 and the upper mold 31 to face the molding surface 42 of the lower mold 41 and the molding surface 32 of the upper mold 31 each other, a molding space for the pad body 52 is formed by the cavities 33, 43.

The lower mold 41 includes a pair of first ribs 44 located on the right and left sides thereof and a second rib 45 connecting the pair of first ribs 44, all of which are raised from the molding surface 42. The first ribs 44 are ribs extending in the front-to-rear direction and portions for forming longitudinal grooves 56 (see FIG. 5B) in the pad body 52. The second rib 45 is a rib extending in the right-to-left direction and a portion for forming a transverse groove 55 (see FIG. 5A) in the pad body 52.

Each of the first ribs 44 and the second rib 45 includes magnets 46, 47 (permanent magnets) embedded therein at a plurality of locations spaced apart in the longitudinal direction. The lower mold 41 is made of aluminum alloy and the magnets 46, 47 are members for attracting the magnetic layers 22, 24, respectively, formed on the upholstery engaging members 21, 23 (see FIG. 2) by a magnetic force. The magnetic layers 22 are formed on the upholstery engaging members 21 corresponding to the relative positions of the magnets 46 of the first ribs 44, while the magnetic layers 24 are formed on the upholstery engaging member 23 corresponding to the relative positions of the magnets 47 to the second rib 45.

Next, a description will be given of a method for producing the sheet pad 51. First, with the upper mold 31 opened from the lower mold 41, the magnetic layers 5 of the reinforcing fabric 1 are attracted to the magnets 34 embedded in the upper mold 31 to secure the reinforcing fabric 1 to the upper mold 31. Furthermore, the magnetic layers 22, 24 of the upholstery engaging members 21, 23 are attracted to the magnets 46, 47 embedded in the lower mold 41 to secure the upholstery engaging members 21, 23 to the lower mold 41 (securing step).

Next, an expandable synthetic resin material (a liquid source material of polyurethane) as a source material for the pad body 52 is poured into the lower mold 41, the upper mold 31 is placed over the lower mold 41 to close the mold, and the expandable synthetic resin material is then expanded to mold it into the pad body 52 (molding step). After being cured for a predetermined period of time, the mold is opened and the molded pad body 52 is removed from the mold. Thus, the expandable synthetic resin material penetrates the reinforcing fabric 1 and cures, so that the reinforcing fabric 1 is bonded integrally to the back surface 54 of the pad body 52. Furthermore, the upholstery engaging members 21, 23 are embedded in the bottoms of the longitudinal grooves 56 and transverse groove 55, respectively, in the pad body 52. Thus, a sheet pad 51 is obtained in which the reinforcing fabric 1 and the upholstery engaging members 21, 23 are integrated with the pad body 52 made of expanded synthetic resin.

In this method for producing the sheet pad 51, since the magnetic layers 5, 22, 24 formed on the surfaces of the reinforcing fabric 1 and the upholstery engaging members 21, 23 are cured forms of the adhesive mixed with ferromagnetic powder, this can simplify the work for imparting magnetism to the reinforcing fabric 1 and the upholstery engaging members 21, 23. Furthermore, this method can simplify the work for preparing in advance the reinforcing fabric 1 and upholstery engaging members 21, 23 on which the magnetic layers 5, 22, 24 are formed.

In addition, since the magnetic layers 5, 22, 24 are bonded to the reinforcing fabric 1 and the upholstery engaging members 21, 23 by the adhesive, it can be prevented that during the work the magnetic layers 5, 22, 24 are displaced or removed (prior to the securing to the mold). As a result, it can be prevented that the reinforcing fabric 1 and the upholstery engaging members 21, 23 become unable to be secured to the mold or move out of securing position.

Furthermore, since the magnetic layers 5, 22, 24 have flexibility, the magnetic layer 5 can follow the deformation of the reinforcing fabric 1 and the upholstery engaging members 21, 23 involved in the flexion of the pad body 52. Since the magnetic layers 5, 22, 24 can follow the deformation of the reinforcing fabric 1 and the upholstery engaging members 21, 23, it is possible to reduce the delamination and breakage of the magnetic layers 5, 22, 24 due to the deformation of the pad body 52. As a result, it can be prevented that the magnetic layers 5, 22, 24 delaminates or breaks during use of the sheet pad 51 to produce flakes or fragments of the magnetic layers 5, 22, 24 and that the flakes or fragments come contact with the skin of a sitting person to cause discomfort.

Each of the first ribs 44 and the second rib 45 includes magnets 46, 47 embedded therein at a plurality of locations spaced apart in the longitudinal direction and the magnetic layers 22, 24 are formed on the upholstery engaging members 21, 23 corresponding to the relative positions of the magnets 46, 47 to the first ribs 44 and the second rib 45. As a result, by an attractive force between the magnets 46, 47 and the magnetic layers 22, 24, the upholstery engaging members 21, 23 can be attracted to specified positions on the first ribs 44 and the second rib 45. Therefore, the accuracy of positioning the upholstery engaging members 21, 23 can be increased.

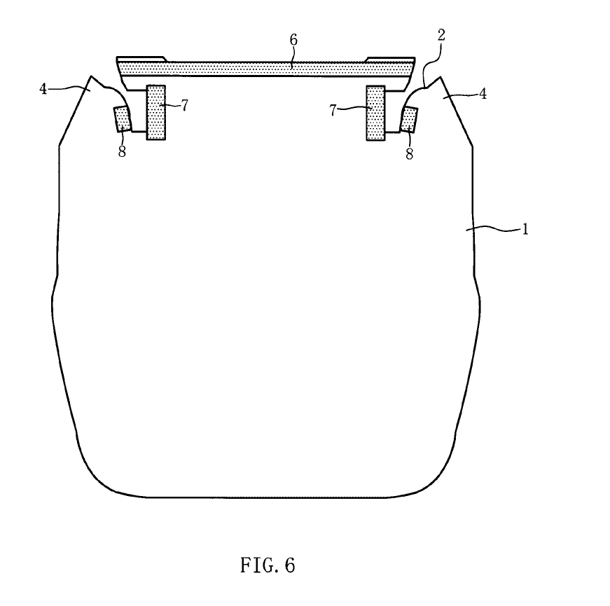

Referring next to FIG. 6, a description will be given of a modification of a reinforcing fabric 1. In the first embodiment, the description has been given of the case where circular magnetic layers 5 are formed on the reinforcing fabric 1. In this modification, unlike the above, a description will be given of the case where strip-shaped magnetic layers 6, 7, 8 are formed on the reinforcing fabric 1. The same elements as those in the first embodiment are designated by the same references and further explanation thereof will be accordingly omitted. FIG. 6 is a plan view of the reinforcing fabric 1 in the modification.

As shown in FIG. 6, strip-shaped magnetic layers 6, 7, 8 are formed on the reinforcing fabric 1. The magnetic layers 6, 7, 8 are formed by applying an adhesive to the reinforcing fabric 1 with a roller. Since the magnetic layers 6, 7, 8 are formed by the application of an adhesive with a roller, the widths of the magnetic layers 6, 7, 8 can be set by the width of the roller and the lengths of the magnetic layers 6, 7, 8 can be arbitrarily selected depending upon the distance over which the roller is moved. As a result, the degree of freedom of size of the magnetic layers 6, 7, 8 can be increased. The positions and sizes of the magnetic layers 6, 7, 8 can be selected depending upon the positions and sizes of the magnets disposed on the upper mold 31 (see FIG. 3).

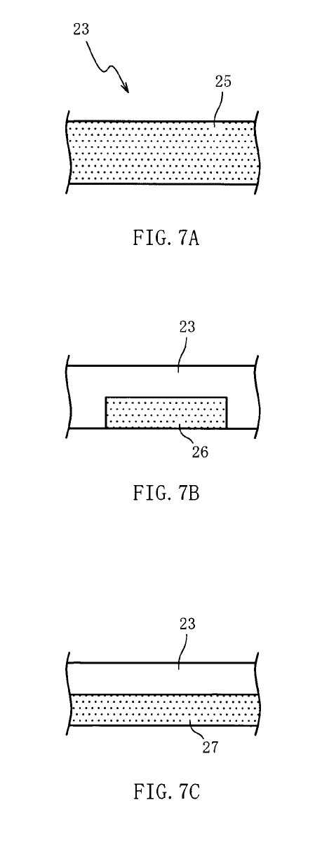

Referring next to FIG. 7, a description will be given of modifications of an upholstery engaging member 23. In the first embodiment, the description has been given of the case where a plurality of magnetic layers 24 formed on the outer periphery of the upholstery engaging member 23 annularly in the circumferential direction thereof are provided at intervals in the length direction. In these modifications, unlike the above, a description will be given of the case where the positions and sizes of magnetic layers 25, 26, 27 formed on the upholstery engaging member 23 are different from those in the first embodiment. The same elements as those in the first embodiment are designated by the same references and further explanation thereof will be accordingly omitted. FIG. 7A is a side view of an upholstery engaging member 23 in a modification, FIG. 7B is a side view of an upholstery engaging member 23 in another modification, and FIG. 7C is a side view of an upholstery engaging member 23 in still another modification. In FIGS. 7A to 7C, a portion of the upholstery engaging member 23 in the longitudinal direction is not shown.

The upholstery engaging member 23 shown in FIG. 7A includes a magnetic layer 25 formed on the entire outer periphery thereof. The magnetic layer 25 is formed, for example, by applying an adhesive to the entire surface (outer periphery) of the upholstery engaging member 23 by dipping of the upholstery engaging member 23 into the adhesive, and then curing the adhesive. This modification can simplify the application of an adhesive to the upholstery engaging member 23 and the formation of the magnetic layer 25 on the upholstery engaging member 23.

The upholstery engaging member 23 shown in FIG. 7B is provided with magnetic layers 26 formed on the outer periphery thereof over an approximately half of the circumference (i.e., approximately the semicircumference) and at intervals in the length direction. The magnetic layers 26 are formed, for example, by applying an adhesive to the surface (outer periphery) of the upholstery engaging member 23 by transfer of the adhesive applied on a stamp surface (concave surface) and then curing the adhesive. In this modification, since the magnetic layers 26 are formed on the outer periphery of the upholstery engaging member 23 over an approximately half of the circumference (approximately the semicircumference), the amount of adhesive consumed can be reduced to almost half as compared to the case where the magnetic layers 24 (see FIG. 2) are formed on the outer periphery of the upholstery engaging member 23 over the entire circumference. As a result, the production cost can be reduced by the reduction of the amount of adhesive consumed.

The upholstery engaging member 23 shown in FIG. 7C includes a magnetic layer 27 formed on the outer periphery thereof over an approximately half of the circumference. The magnetic layer 27 is formed, for example, by applying an adhesive to an approximately half of the surface (outer periphery) of the upholstery engaging member 23 by dipping of the upholstery engaging member 23 into the adhesive, and then curing the adhesive. In this modification, since the magnetic layer 27 is formed on the outer periphery of the upholstery engaging member 23 over an approximately half of the circumference (approximately the semicircumference), the amount of adhesive consumed can be reduced to almost half as compared to the case where the magnetic layer 25 (see FIG. 7A) is formed on the entire outer periphery. As a result, the production cost can be reduced by the reduction of the amount of adhesive consumed.

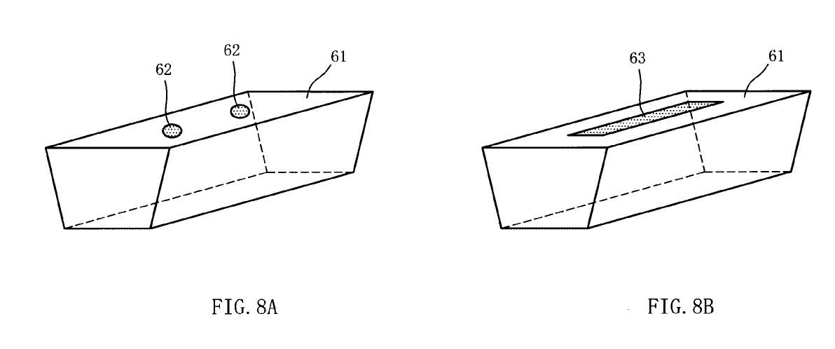

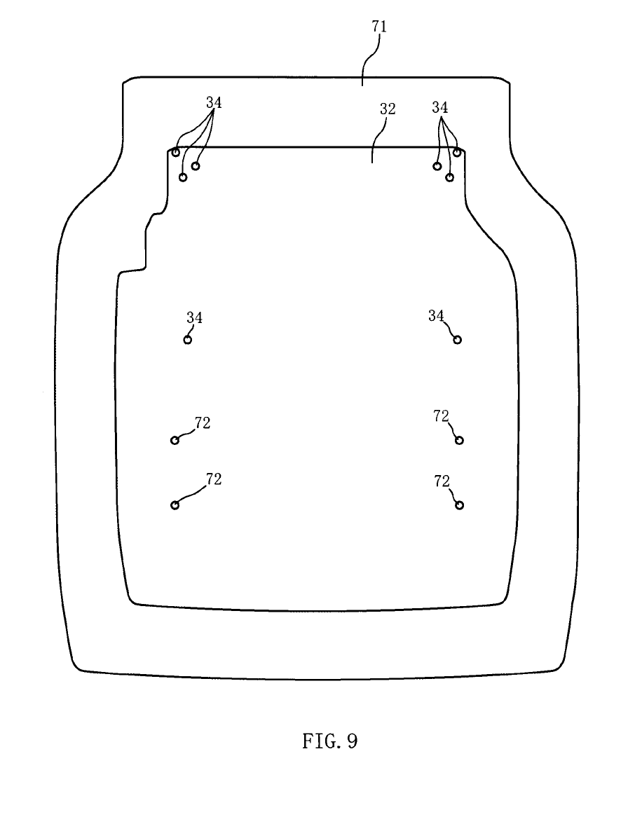

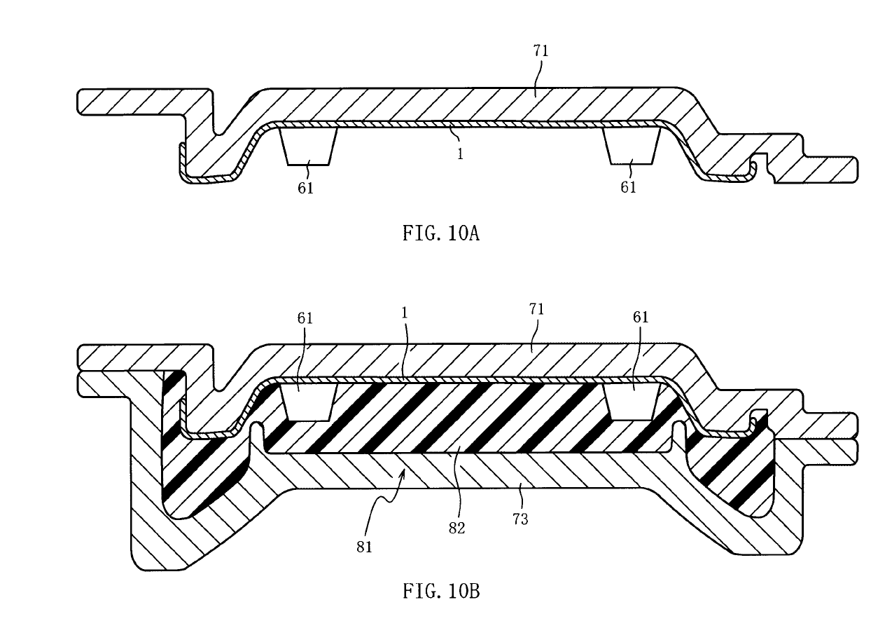

Next, a description will be given of a second embodiment with reference to FIGS. 8 to 10. In the first embodiment, the description has been given of the case where magnetic layers 5, 22, 24 are formed on the reinforcing fabric 1 and the upholstery engaging members 21, 23. In the second embodiment, unlike the above, a description will be given of the case where magnetic layers 62 are formed on, in addition to the reinforcing fabric 1, expanded resin bodies 61. The same elements as those in the first embodiment are designated by the same references and further explanation thereof will be accordingly omitted. FIG. 8A is a perspective view of an expanded resin body 61 (insert member) to be integrated with a sheet pad 81 in the second embodiment and FIG. 8B is a perspective view of an expanded resin body 61 in a modification. FIG. 9 is a bottom view of an upper mold 71, FIG. 10A is a cross-sectional view of the upper mold 71 in the right-to-left direction, and FIG. 10B is a cross-sectional view of a mold (the upper mold 71 and a lower mold 73) during molding of a pad body 82.

The expanded resin body 61 shown in FIG. 8A is an elastic member made of expanded synthetic resin having a greater hardness than the pad body 82 (see FIG. 10B) and is formed in the shape of a quadratic prism having a trapezoidal bottom surface. In this embodiment, the expanded resin body 61 is a urethane slab formed by cutting a polyurethane foam molded using a mold (not shown). Circular magnetic layers 62 are formed on a rectangular side surface of the expanded resin body 61. The magnetic layers 62 are portions having flexibility by curing of an adhesive mixed with ferromagnetic powder and are formed at two locations on the side surface spaced apart in the longitudinal direction. The magnetic layers 62 are formed by transfer of the adhesive applied on a circular stamp surface or screen printing.

As shown in FIG. 8B, the expanded resin body 61 in another modification includes a magnetic layer 63 formed in a strip on a side surface thereof to extend in the longitudinal direction of the side surface. The magnetic layer 63 is formed in a strip by application with a brush or a roller. Since the magnetic layer 63 is formed by application with a brush or a roller, the magnetic layer 63 can be easily formed.

As shown in FIG. 9, the upper mold 71 for forming the bottom side of the pad body 82 (see FIG. 10B) includes magnets 72 (permanent magnets) embedded at a plurality of locations in a molding surface 32 thereof. The magnets 72 are members for attracting the magnetic layers 62 formed on the expanded resin bodies 61 (see FIG. 8A) by a magnetic force. The magnetic layers 62 are formed on the expanded resin bodies 61 corresponding to the relative positions of the magnets 72 to the upper mold 71.

Referring next to FIGS. 10A and 10B, a description will be given of a method for producing the sheet pad 81. First, with the upper mold 71 opened from the lower mold 73, the magnetic layers 5 of the reinforcing fabric 1 (see FIG. 1) are attracted to the magnets 34 (see FIG. 9) embedded in the upper mold 71 to secure the reinforcing fabric 1 to the upper mold 71. Subsequently, the magnetic layers 62 of the expanded resin bodies 61 are attracted to the magnets 72 embedded in the upper mold 71 to secure the expanded resin bodies 61 to the upper mold 71 from on top of the reinforcing fabric 1 (securing step).

Next, an expandable synthetic resin material (a liquid source material of polyurethane) as a source material for the pad body 82 is poured into the lower mold 73, the upper mold 71 is placed over the lower mold 73 to close the mold, and the expandable synthetic resin material is then expanded to mold it into the pad body 82 (molding step). After being cured for a predetermined period of time, the mold is opened and the molded pad body 82 is removed from the mold. Thus, the expandable synthetic resin material penetrates the reinforcing fabric 1 and cures, so that the reinforcing fabric 1 is bonded integrally to the back surface of the pad body 82. In addition, the expanded resin bodies 61 are integrated with the pad body 82. Thus, a sheet pad 81 is obtained in which the reinforcing fabric 1 and the expanded resin bodies 61 are integrated with the pad body 82 made of expanded synthetic resin.

In this sheet pad 81, the expanded resin bodies 61 are arranged so as to be located laterally outside the hip of a person when sitting on the sheet pad 81, so that the hip of the sitting person can be supported from laterally outside by the expanded resin bodies 61. Thus, the hip holdability can be ensured and the postural stability of the sitting person can be increased.

This method for producing the sheet pad 81 can achieve the same effects as those described in the first embodiment. Furthermore, the magnetic layers 62 of the expanded resin bodies 61 are attracted to the magnets 72, so that the reinforcing fabric 1 is secured sandwiched between the expanded resin bodies 61 and the upper mold 71. Since the attractive force between the magnets 72 and the magnetic layers 62 enables the reinforcing fabric 1 and the expanded resin bodies 61 to be secured in a superposed relation to the upper mold 71, the workability in securing the reinforcing fabric 1 and the expanded resin bodies 61 to the upper mold 71 can be increased.

In this relation, there is a means of securing the expanded resin bodies 61 by providing, instead of the magnets 72, pins raised from the molding surface 32 of the upper mold 71, providing the expanded resin bodies 61 with, instead of the magnetic layers 62, holes into which the pins are to be inserted, and inserting the pins into the holes in the expanded resin bodies 61 to secure the expanded resin bodies 61 to the upper mold 71. In this case, in order to provide the reinforcing fabric 1 between the expanded resin bodies 61 and the upper mold 71, it is necessary to provide the reinforcing fabric 1 with holes capable of receiving the pins. Therefore, the work for opening the holes in the reinforcing fabric 1 is required.

Furthermore, when the molded pad body 82 is removed from the mold, the expanded resin bodies 61 may come into contact with the pins to suffer damage to portions thereof surrounding the holes. In addition, since the expanded resin bodies 61 are exposed through the holes opened in the reinforcing fabric 1, the sheet pad 81 has a problem in that, during use, abnormal noises are easily produced owing to friction between the sheet frame (not shown) and the expanded resin bodies 61 and the expanded resin bodies 61 are easily damaged.

Unlike the above, in this embodiment, since the reinforcing fabric 1 and the expanded resin bodies 61 are secured by, instead of pins, the attractive force between the magnets 72 and the magnetic layers 62, this eliminates the need for the work for opening holes in the reinforcing fabric 1. Furthermore, because the use of the magnetic force eliminates the need for the work for inserting pins into holes, the workability in securing the expanded resin bodies 61 to the upper mold 71 can be increased. In addition, since the upper mold 71 is provided with no pin, it is avoided that when the molded pad body 82 is removed from the mold, the expanded resin bodies 61 may come into contact with the pins to suffer damage. Moreover, since no holes receiving pins are opened in the reinforcing fabric 1, it can be prevented that abnormal noises are produced owing to friction between the sheet frame (not shown) and the expanded resin bodies 61 and the expanded resin bodies 61 are damaged.

Although the present invention has been described so far with reference to the embodiments, the present invention is not limited to the above embodiments and it can be easily inferred that various modifications and changes can be made without departing from the spirit of the present invention. For example, the shapes described in the above embodiments are merely illustrative and it is naturally possible to employ other shapes.

Although in the above embodiments the reinforcing fabric 1, the upholstery engaging members 21, 23, and the expanded resin body 61 are exemplified as insert members where magnetic layers 5, 6, 7, 8, 22, 24, 25, 26, 27, 62, 63 are provided, the insert member is not necessarily limited to them. Any member capable of being insert molded in the pad body can be appropriately selected as the insert member. Examples of the insert member other than the reinforcing fabric 1, the upholstery engaging member 21, 23, and the expanded resin body 61 include: synthetic resin members, such as a holder for holding an attachment provided on an upholstery (not shown) covering the sheet pad 51, 81; fiber members, such as solid cotton and a 3D network body; rubber elastic bodies, such as urethane rubber; and synthetic resin elastic bodies, such as thermoplastic elastomer.

The 3D network body is a three-dimensional network structure formed by a plurality of three-dimensionally intertwined fibers, is made of fibers of thermoplastic elastomer, such as thermoplastic polyester elastomer or thermoplastic polyurethane elastomer, cotton, wool, rayon, nylon or polyester, and has air permeability and elasticity.

Although in the above second embodiment the description has been given of the case where the expanded resin body 61 is a urethane slab formed by cutting a polyurethane foam molded using a mold, the expanded resin body is not necessarily limited to this and other types of expanded resin bodies can be naturally employed. Examples of other expanded resin bodies include urethane chips formed by crushing pieces produced in the process of manufacturing a flexible polyurethane foam, and expanded synthetic resin, such as expanded polystyrene.

Although in the above embodiments the description has been given of the case where the sheet pad 51, 81 is a base material for a cushion pad lying under the hip of a sitting person, the sheet pad is not necessarily limited to this and can be naturally applied to other types of sheet pads, such as a sheet pad forming a back pad.

Although in the above embodiments the description has been given of the case where the upper mold 31, 71 and the lower mold 41, 73 are provided with permanent magnets, the present invention is not necessarily limited to this and it is naturally possible to use electromagnets instead of the permanent magnets.

Although in the above embodiments the description has been given of the case where the magnets generating magnetic fields are disposed on the upper mold 31, 71 and the lower mold 41, 73 to attract the magnetic layers 5, 6, 7, 8, 22, 24, 25, 26, 27, 62, 63 provided on the reinforcing fabric 1, the upholstery engaging members 21, 23, and the expanded resin bodies 61, the present invention is not necessarily limited to this. In contrast, it is naturally possible to allow the magnetic layers 5, 6, 7, 8, 22, 24, 25, 26, 27, 62, 63 to generate magnetic fields and attract ferromagnetic members disposed on the upper mold 31, 71 and the lower mold 41, 73.

In the first embodiment, the description has been given of the case where by superposing the distal end of each end edge 4 on the adhesive applied to the distal end of the end edge 3 before the adhesive cures, both the distal ends of the end edges 3, 4 are bonded together concurrently with the formation of the magnetic layers 5 due to curing of the adhesive. However, the bonding of the distal ends of the end edges 3, 4 with an adhesive is not necessarily needed. It is naturally possible that at the time of securing the reinforcing fabric 1 to the upper mold 31 after the adhesive applied to the distal end of the end edge 3 of the reinforcing fabric 1 is cured to form a magnetic layer 5, the end edge 4 is sandwiched between the magnet 34 and the magnetic layer 5 (end edge 3). Because the end edges 3, 4 are secured in a superposed relation by a magnetic force even if the distal ends of the end edges 3, 4 are not bonded by an adhesive, this can eliminate the need for the work for bonding together the distal ends of the end edges 3, 4 of the reinforcing fabric 1 and increase the workability in securing the reinforcing fabric 1 to the upper mold 31.

1. An insert member capable of being integrated with a pad body made of expanded synthetic resin,
wherein a magnetic layer in which an adhesive mixed with ferromagnetic powder is cured is formed on a surface of the insert member.

2. The insert member according to claim 1, wherein the magnetic layer has flexibility.

3. A sheet pad comprising:
the insert member according to claim 1; and
a pad body made of expanded synthetic resin and integrated with the insert member.

4. A method for producing a sheet pad, the method comprising:
a securing step of securing the insert member according to claim 1 to a mold by attracting the magnetic layer by a magnetic force; and
a molding step of molding a pad body of expandable synthetic resin in the mold inside which the insert member is secured thereto, thereby integrating the insert member with the pad body.

5. The method for producing a sheet pad according to claim 4, wherein the securing step includes securing the insert member so that a portion of the insert member having the magnetic layer formed thereon and the mold sandwich another portion of the insert member therebetween.
